(19) United States
(12) Patent Application Publication
(10) Pub. No.: US 2014/0013965 A1
(43) Pub. Date: Jan. 16, 2014

(54) BATTERY POWERED FOOD WARMER

(71) Applicant: John Perez, Plantation, FL (US)

(72) Inventor: John Perez, Plantation, FL (US)

(21) Appl. No.: 14/040,621

(22) Filed: Sep. 28, 2013

Related U.S. Application Data
(63) Continuation-in-part of application No. 13/943,774, filed on Jul. 16, 2013.
Application No. 13/943,774 is a continuation of application No. 13/857,619, now abandoned.
(60) Provisional application No. 61/620,762, filed on Apr. 5, 2012.

(51) Int. Cl. A47J 39/00

(52) U.S. Cl. CPC A47J 39/006
USPC 99/483

(57) ABSTRACT

The food warmer apparatus is disclosed. The food warmer includes a water pan for holding water, a housing for supporting the water pan, a food pan supported by the water pan above the water, and an electrical heating element located underneath, and in conductive contact with, the water pan, so as to heat the water in the water pan. The food warmer also includes a first and second removable battery for providing power to the electrical heating element, and a processor conductively coupled with the electrical heating element and with the first and second removable batteries, wherein the processor is configured for engaging a switch for relaying power to the electrical heating element from the first battery, detecting that the first battery has depleted below a threshold, and engaging a switch for relaying power to the electrical heating element from the second battery.

### CROSS-REFERENCE TO RELATED APPLICATIONS

This patent application is a continuation in part of patent application Ser. No. 13/943,774 filed on Jul. 16, 2013 and titled “Battery powered food warmer,” which is a continuation in part of patent application Ser. No. 13/857,619 filed on Apr. 5, 2013 and titled “Battery powered food warmer,” which claims priority to provisional patent application No. 61/620,762 filed on Apr. 5, 2012 and titled “Battery powered food warmer.”

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of food service, and more particularly relates to the field of devices for maintaining food at desired temperatures.

### BACKGROUND OF THE INVENTION

A food warmer or food chafer is a portable apparatus that is widely used for buffet type food service, serving hors d'oeuvres and other purposes. Food warmers typically include a water pan supported by a frame and a food pan supported by the water pan above the level of water in the water pan. The water in the pan is heated by a heat source to keep the food in the food pan warm—preferably at temperatures from 140 degrees to about 190 degrees Fahrenheit. The heat source for a food warmer is typically referred to as a candle lamp or gel fuel, which comprises a gel-like substance in a can that is ignited and burns slowly. More modern versions of food warmers may be electric and are powered via a power chord that is plugged into a wall electrical outlet.

One of the problems with currently available fuel-based food warmers is the amount of maintenance necessary to maintain the apparatus in working condition during food service. The food warmer's fuel must be constantly checked and immediately replaced if depleted. Visually checking the food warmer fuel can be difficult, since the flame is mostly transparent. If a food worker does not notice that the food warmer fuel has depleted, even after only a few minutes, this can negatively impact the desired temperature of the food in the warmer. Further, over time, food warmer fuel can add to the expense of operating fuel-based food warmers. Another problem with currently available fuel-based food warmers is safety. Having combustible fuel indoors during social events can be hazardous and potentially life-threatening. Yet another issue with conventional fuel-based food warmers is the inability to regulate temperature. Because food warmer fuel combusts at a defined temperature, it cannot be adjusted. This is a disadvantage, since food workers may desire to serve different foods at varying temperatures.

A well-known problem for electrical-based food warmers is the requirement that the food warmer is near a wall electrical outlet, such that the food warmer's power chord may be plugged into the wall electrical outlet. This is not always possible, when social events are situated outside or in areas that do not have wall electrical outlets available. Thus, electrical-based food warmers have limited uses and lack versatility.

Therefore, a need exists to overcome the problems with the prior art as discussed above, and particularly for a more efficient way to maintain food warmers at desired temperatures while limiting the amount of maintenance that a food warmer requires.

### SUMMARY OF THE INVENTION

Briefly, according to the disclosed embodiments, a food warmer apparatus is disclosed. The food warmer includes a water pan for holding water, a housing for supporting the water pan, a food pan supported by the water pan above the water in the water pan, and an electrical heating element located underneath, and in conductive contact with, the water pan, so as to heat the water in the water pan. The food warmer also includes a first removable battery and a second removable battery for providing power to the electrical heating element, and a processor conductively coupled with the electrical heating element and with the first and second removable batteries, wherein the processor is configured for engaging a switch for relaying power to the electrical heating element from the first battery, detecting that the first battery has depleted below a predefined threshold, and engaging a switch for relaying power to the electrical heating element from the second battery.

In another embodiment, the food warmer includes a lid for placement on top of the food pan, and a pair of removable brackets located on a side of the housing for holding the lid when removed from the food pan. In yet another embodiment, the food warmer includes a communications module including a radio frequency transmitter for transmitting a current charge status of each of the first and second removable batteries and a current temperature of the food warmer.

The foregoing and other features and advantages of the present invention will be apparent from the following more particular description of the preferred embodiments, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 is an illustration of top perspective view of the battery powered food warmer, in accordance with one embodiment.

FIG. 2 is an illustration of rear view of the battery powered food warmer, in accordance with one embodiment.

FIG. 3 is an illustration of a side view of the battery powered food warmer, in accordance with one embodiment.

FIG. 4 is an illustration of top cross-sectional view of the battery powered food warmer, in accordance with one embodiment.

FIG. 5 is an illustration of a frontal cross-sectional view of the battery powered food warmer, in accordance with one embodiment.

FIG. 6 is an illustration of a side cross-sectional view of the battery powered food warmer, in accordance with one embodiment.

FIG. 7 is an illustration of a block diagram of the main components of the battery powered food warmer, in accordance with one embodiment.

FIG. 8 is an illustration of a block diagram showing the communications process of the battery powered food warmer, in accordance with one embodiment.

### DETAILED DESCRIPTION

The disclosed embodiments solve problems with the prior art by providing a simplified, battery-powered food warmer apparatus. The food warmer apparatus improves over the prior art by providing a food warmer that neither requires combustible fuel, nor a power cord and electrical outlet to operate. The food warmer apparatus is powered by a battery pack that provides all of the necessary electrical power to operate the food warmer. These features lower the expense of operating the food warmer and eliminate the hazards of having combustible fuel at a social event. Additionally, the food warmer of the disclosed embodiments allow for adjustment of the temperature of the food warmer. This allows for variable food temperatures, which increases the usability and versatility of the food warmer. Also, the food warmer of the disclosed embodiments allow for remote detection of the temperature of the food warmer and the status of the battery. The food warmer apparatus may also include at least one display for displaying the temperature of the food warmer and the current battery status, as well as one or more visual indicators for indicating the current battery status. This allows for quick and easy detection of cases when the battery is depleted and the temperature of the food is decreasing and allows for expedited changing of the removable battery to maintain the food at a desired temperature.

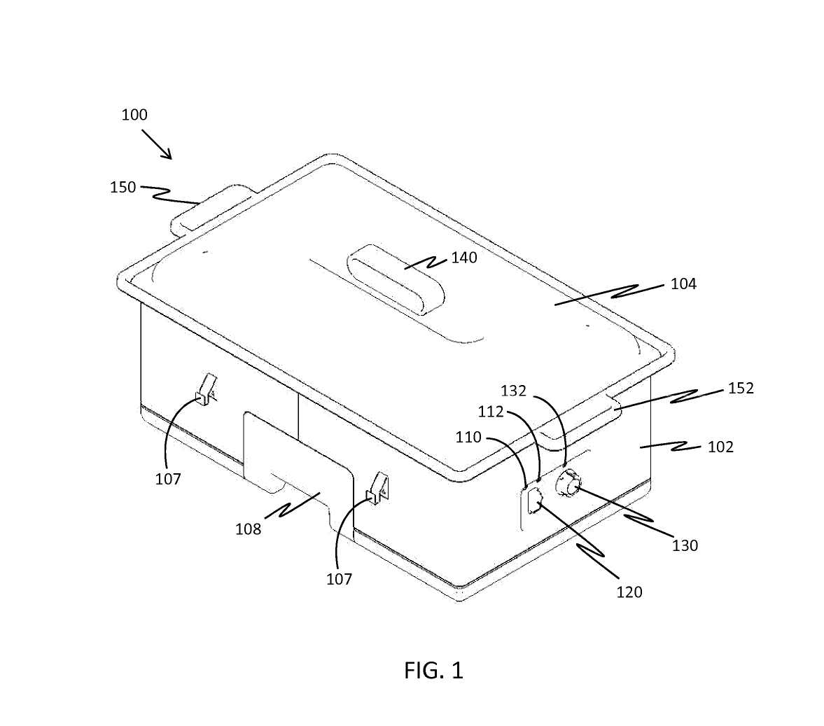

The battery-powered food warmer apparatus of the disclosed embodiments will now be described with reference to FIGS. 1 through 8. FIG. 1 is an illustration of top perspective view of the battery powered food warmer 100, in accordance with one embodiment. The food warmer 100 includes a housing 102 for housing various internal components of the food warmer 100. Internal to the housing 102 is a water pan supported by the housing 102 and a food pan that rests within the water pan above the level of the water in the water pan. FIG. 1 also shows a lid 104 for placement on top of the housing 102, namely, for covering the food pan. A handle 140 is shown on top of the lid 104, while the housing 102 also include two opposing handles 150, 152 for carrying the entire food warmer 100.

A control panel (or user input interface) on one side of the food warmer 100 includes an on-off switch 120 for activating and deactivating the food warmer 100 and an adjustable dial 130 for allowing a user to set the desired temperature of the food warmer 100. The control panel also includes an LED light 132 for indicating the active/inactive status of the food warmer and a pair of LED lights 110, 112 for indicating the charge status of the multiple removable batteries of the food warmer 100. Light 132 may, for example, light up in the color green when the food warmer 100 is activated and may light up in the color red (or simply will not light), when the food warmer 100 is deactivated. Each of the LED lights 110, 112 may correspond to one of a pair of removable batteries. Each light 110, 112 may, for example, light up in the color green when the corresponding battery is fully charged, light up in the color orange or yellow when the corresponding battery is halfway depleted, and light up in the color red (or simply will not light) when the corresponding battery is fully depleted. In one embodiment, a light 110, 112 may blink red when the corresponding battery is depleted or near depleted. The control panel provides for easy inspection of the food warmer 100, so as to ensure it is operating at the desired temperature, and easy inspection of the batteries powering the food warmer 100, so that the batteries may be replaced or recharged immediately upon detection of depletion.

In one alternative, in lieu of the dial 130, the control panel may include one or more buttons that for allowing a user to set the desired temperature of the food warmer 100. For example, an upwards facing or up-arrow shaped button may be used to increase the desired temperature of the food warmer and a downwards facing or down-arrow shaped button may be used to decrease the desired temperature of the food warmer. In another alternative, the control panel includes a display that displays a current temperature of the food warmer and/or the electrical heating element(s), or, in the alternative, the desired temperature of the food warmer. This display may be a numerical display, an LCD, or the like.

FIG. 1 also shows removable brackets 107 located on the rear panel of the housing 102 of the food warmer 100. The brackets 107 accept the lid 104 such that the lid 104 may be inserted into the brackets 107 when the lid 104 is removed from the housing 102. This feature provides a convenient location for the lid 104 in situations where there is little table space to place the lid 104. FIG. 1 also shows a removable shelf 108 located in the rear panel of the housing 102 of the food warmer 100. The shelf 108 can be pulled out of the housing 102 and holds one or more removable batteries for powering the food warmer 100. The shelf 108 allows the batteries to easily be pulled out and replaced, wherein the shelf 108 is then re-inserted into the housing 102.

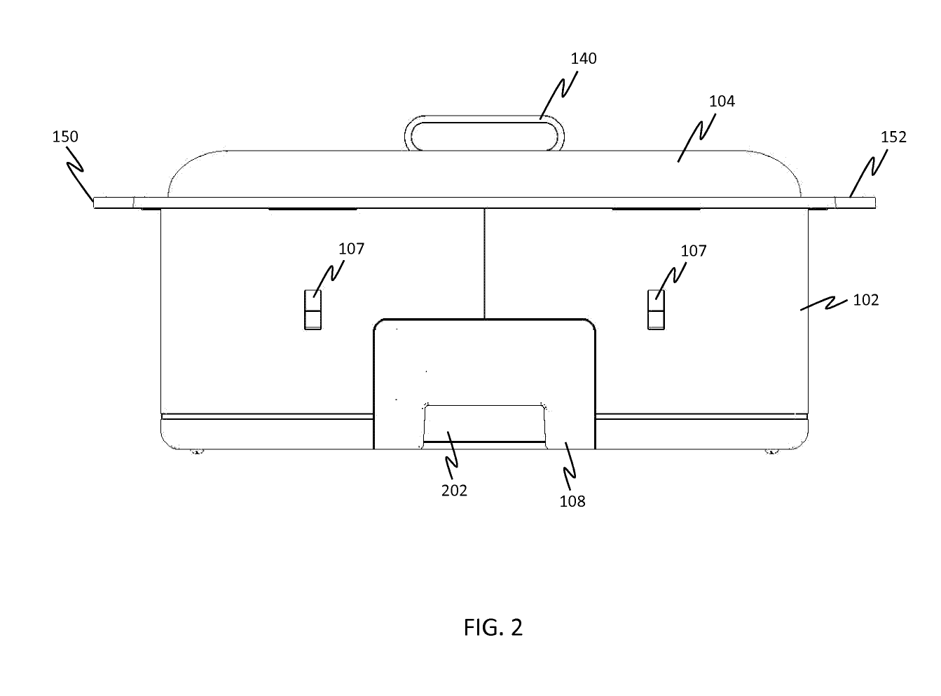

FIG. 2 is an illustration of rear view of the battery powered food warmer 100, in accordance with one embodiment. FIG. 2 shows the removable brackets 107 located on the rear panel of the housing 102 and the removable shelf 108 that can be pulled out of the housing 102 and holds one or more removable batteries for powering the food warmer 100. The shelf 108 may include a depression or pit 202 designed to accept the shape of a person's hand, so as to facilitate the removal of the shelf 108 from the housing 102.

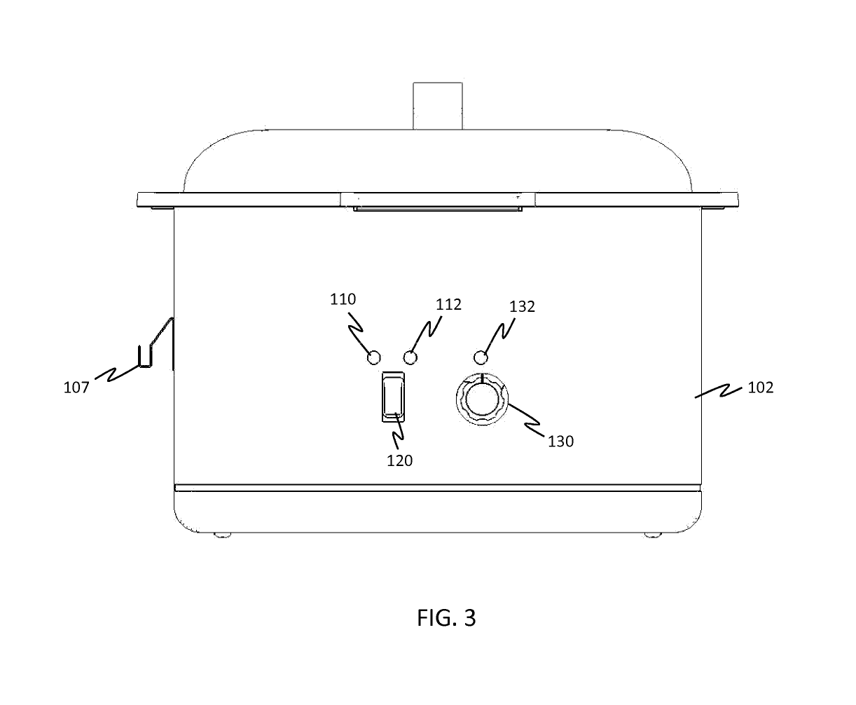

FIG. 3 is an illustration of a side view of the battery powered food warmer 100, in accordance with one embodiment. FIG. 3 shows the control panel on one side of the food warmer 100, which includes an on-off switch 120 for activating and deactivating the food warmer 100 and an adjustable dial 130 for adjusting the desired temperature of the food warmer 100. The control panel also includes an LED light 132 for indicating the active/inactive status of the food warmer and a pair of LED lights 110, 112 for indicating the charge status of the one or more removable batteries of the food warmer 100.

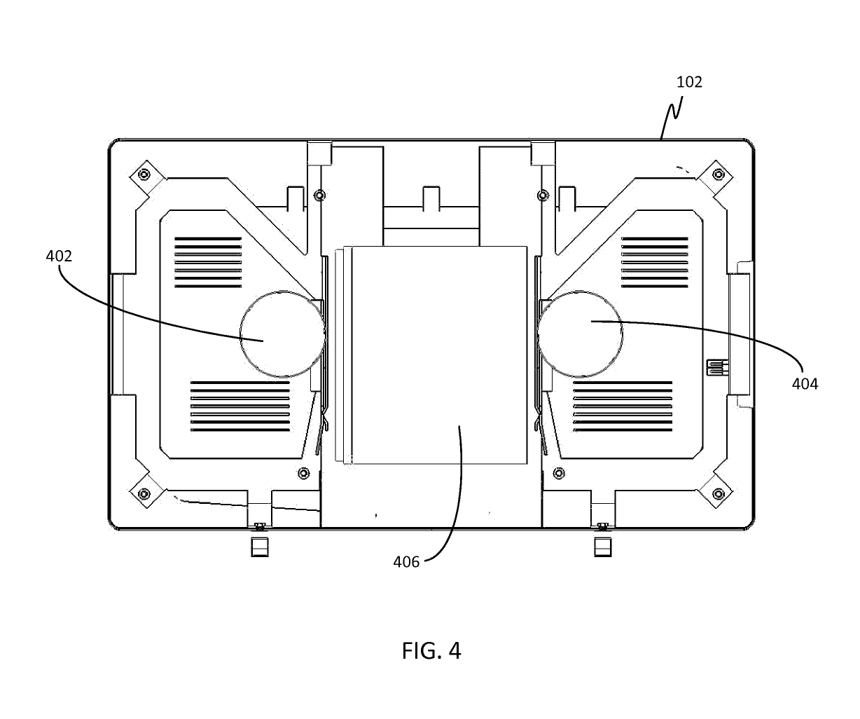

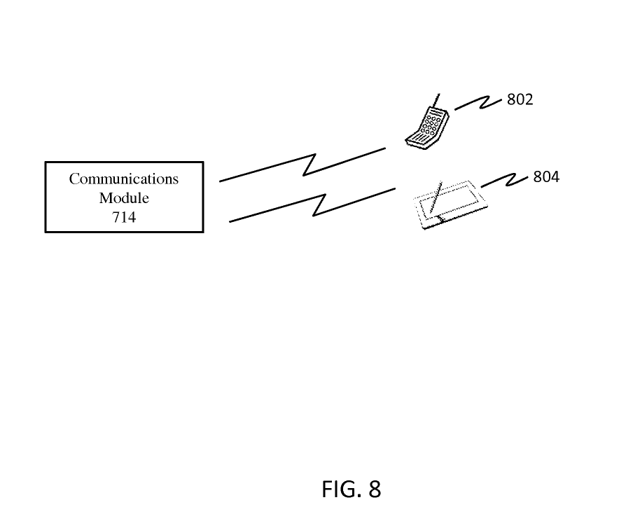

FIG. 4 is an illustration of top cross-sectional view of the battery powered food warmer 100, in accordance with one embodiment. FIG. 4 shows internal components of the food warmer 100 within the housing 102. FIG. 4 shows the location of two electrical heating elements 402, 404 within the housing 102, wherein each element is located centrally underneath the water pan of the food warmer 100. An electrical heating element converts electricity into heat through the process of Joule heating. Electric current through the element, which may be composed of nichrome, for example, encounters resistance, resulting in heating of the element. The component 406 houses various internal components of the food warmer 100, described more fully below with reference to FIG. 8.

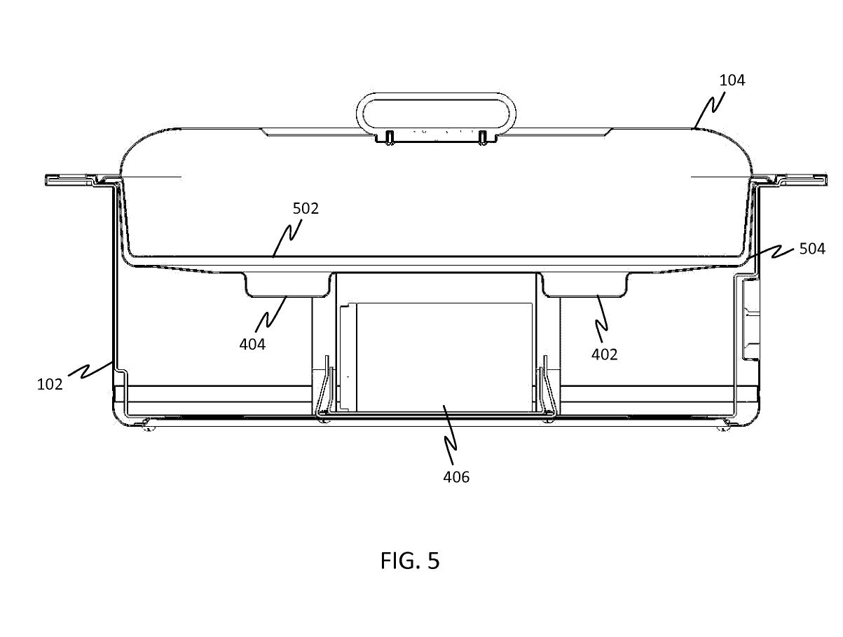

FIG. 5 is an illustration of a frontal cross-sectional view of the battery powered food warmer 100, in accordance with one embodiment. FIG. 5 also shows internal components of the food warmer 100 within the housing 102. FIG. 5 shows that the food warmer 100 includes a water pan 504 that is conductively coupled with the electrical heating elements 402, 404 such that the heating elements provide heat to the water pan 504. The water pan 504 is filled to a certain level with water, which is heated by the water pan 504. The food pan 502 is placed within the water pan 504 and is thus heated by the water in the water pan 504. FIG. 5 also shows the location of the two electrical heating elements 402, 404 underneath the water pan 504 of the food warmer 100. The component 406 houses various internal components of the food warmer 100, described more fully below with reference to FIG. 8.

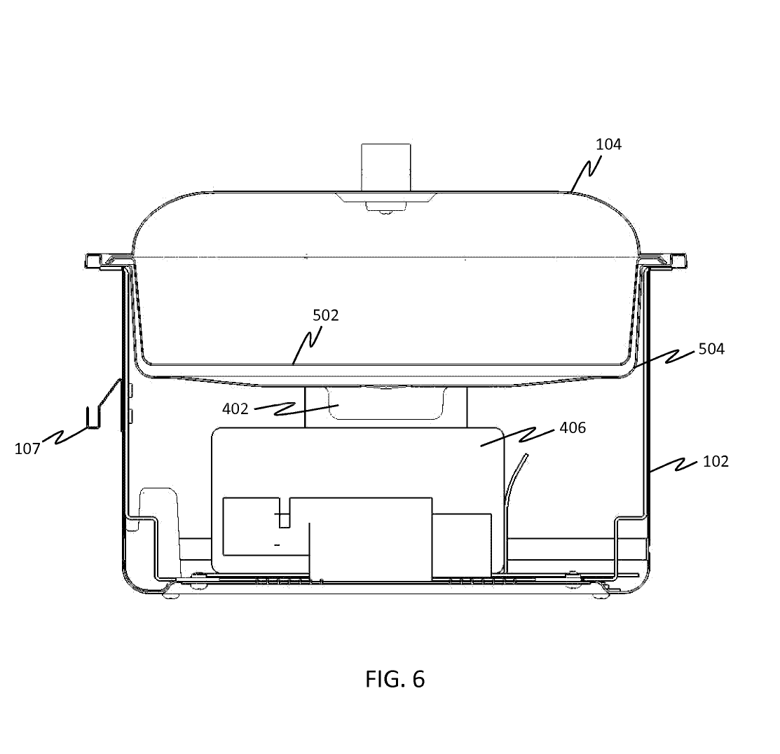

FIG. 6 is an illustration of a side cross-sectional view of the battery powered food warmer 100, in accordance with one embodiment. FIG. 6 also shows internal components of the food warmer 100 within the housing 102. FIG. 6 shows that the food warmer 100 includes a water pan 504 that is conductively coupled with the electrical heating element 402 and that the food pan 502 is placed within the water pan 504 and is thus heated by the water in the water pan 504. FIG. 6 also shows the location of the electrical heating element 402 underneath the water pan 504 of the food warmer 100.

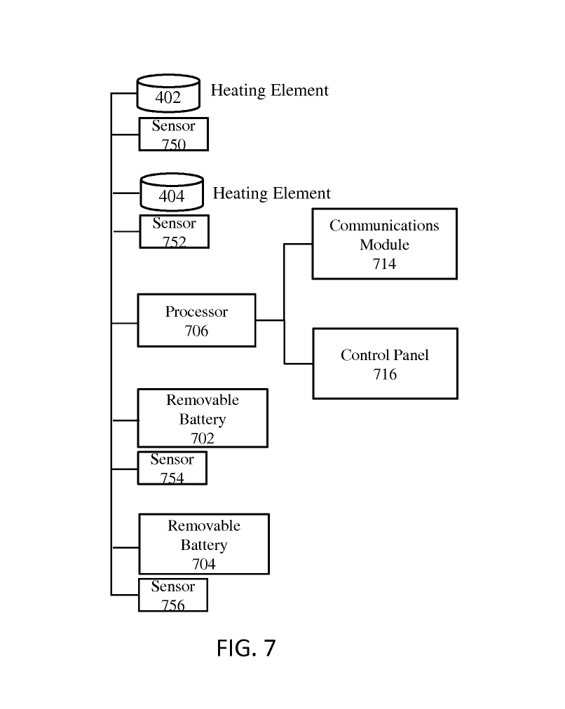

FIG. 7 is an illustration of a block diagram of the main components of the battery powered food warmer 100, in accordance with one embodiment. FIG. 7 shows that the components include the removable battery 702 and the removable battery 704, both of which may be conductively coupled with the processor 706. Each removable battery may be a rechargeable battery, such as a lead-acid, nickel cadmium (NiCd), nickel metal hydride (NiMH), lithium ion (Li-ion), and lithium ion polymer battery. The processor may be a central processing unit, an integrated circuit, an ASIC, a system on a chip, or the like. The processor may further be a microprocessor which incorporates the functions of a computer's central processing unit on a single integrated circuit or a few integrated circuits. The processor 706 may be conductively coupled with the electrical heating elements 402, 404 and with the first and second removable batteries 702, 704.

FIG. 7 also shows that the processor 706 may further be conductively coupled with the communications module 714, described in greater detail below, and the control panel (or user input interface) 716, which comprises the LEDs 110, 112, 132, the switch 120 and the dial 130, as well as any displays for displaying temperatures or other buttons. FIG. 7 further shows that processor 706 may further be conductively coupled with the sensors 750, 752 for sensing and reporting a current temperature of the respective electrical heating element, as well as sensors 754, 756 for sensing and reporting a current charge status of the respective removable battery.

The processor 706 may be configured for reading the desired temperature entered by the user via the control panel 716, engaging a switch for relaying power to the electrical heating elements from the one or more batteries 702, 704, reading a current temperature of the one or more electrical heating elements from the sensor or sensors 750, 752, determining that the current temperature of the one or more electrical heating elements is substantially equal to the desired temperature entered by the user, and engaging a switch for withdrawing power to the electrical heating elements from the batteries. The processor 706 may further be configured for reading a current temperature of the one or more electrical heating elements from the sensor or sensors 750, 752, determining that the current temperature of the one or more electrical heating elements has decreased below the desired temperature entered by the user (or below a defined delta of the desired temperature), and engaging a switch for engaging power to the electrical heating elements from the batteries. Thus, the processor 706 may be configured for maintaining the food warmer at the user's desired temperature.

The processor 706 may further be configured for engaging a switch for relaying power to the electrical heating elements from the first battery 702, detecting that the first battery 702 has depleted below a predefined threshold and engaging a switch for relaying power to the electrical heating elements from the second battery 704. Thus, the processor 706 may be configured for switching the source battery when it is depleted. This feature allows for the food in the food warmer to maintain a desired temperature, even when one of the rechargeable batteries has been depleted.

The processor 706 may read data from the sensors 754, 756, and use this data to adjust the LEDs 110, 112, an alternative display that conveys battery charge status, or another element of control panel 716. The processor 706 may also read data from the sensors 750, 752, and use this data to adjust a display in control panel 716 that conveys a current temperature of the food warmer or the one or more electrical hearing elements. Any data read by processor 706 may be stored in volatile or non-volatile memory for later use.

The processor 706 may also include, or be communicatively coupled with, a voltage regulator that regulates the voltage allocated to the electrical heating elements 402, 404 from the batteries 702, 704, so as to adjust the temperature of the food warmer 100. The processor 706 may read the user's desired temperature from dial 130 (or any other element of control panel 716) and adjust the voltage regulator to adjust the temperature of the food warmer 100 to meet the user's desired temperature. The processor 706 may also include, or be communicatively coupled with, a rheostat that regulates the resistance of the electrical heating elements 402, 404, so as to adjust the temperature of the food warmer 100. The processor 706 may read the user's desired temperature from dial 130 (or any other element of control panel 716) and adjust the rheostat accordingly.

FIG. 7 also shows communications module 714, which may comprise a radio frequency transmitter, such as a Bluetooth compatible module, that transmits certain data about the food warmer 100, such as the current temperature of the food warmer, the current temperature of the electrical heating element(s) (read from sensors 750, 752), the desired temperature entered by the user (into control panel 716), the amount of battery time remaining for each removable battery, and the current charge status of each removable battery (read from sensors 754, 756). The component 406 may house various internal components of the food warmer 100, such as the processor 706 and the communications module 714.

FIG. 8 is an illustration of a block diagram showing the communications process of the battery powered food warmer 100, in accordance with one embodiment. Recall that the communications module 714 comprises a radio frequency transmitter that transmits certain data about the food warmer 100. FIG. 8 shows that the communications module 714 may transmit one or more radio frequency signals that convey certain data about the food warmer 100, such as the current temperature of the food warmer, the current temperature of the electrical heating element(s), the desired temperature entered by the user, the amount of battery time remaining for each removable battery, and the current charge status of each removable battery. Devices 802, 804 (which may be smart phones, tablet computer, laptop computer, desktop computers, etc.) receive the radio frequency signals and may execute a mobile application that receives and displays the data transmitted by the food warmer 100. In another embodiment, the mobile application may receive and display data received from more than one food warmer 100. This feature allows for remote inspection of the food warmer 100, so as to ensure it is operating at the desired temperature, and inspection of the battery powering the food warmer 100.

In a preferred embodiment, the components comprising the water pan 504, the housing 102 and food pan 502, may be manufactured from sheet metal composed of at least one of at least one of aluminum, brass, copper, steel, tin, nickel, titanium, silver, gold, platinum, stainless steel, any alloys of the materials above or any combination of the materials above. In one embodiment, the components comprising the water pan 504 and the housing 102, or a portion thereof, may be comprise a layer of paint, such as a powder coat of paint, on at least one side. The powder coating may be a thermoplastic or a thermoset polymer. The most common polymers used for powder coating are polyester, polyurethane, polyester-epoxy (known as hybrid), straight epoxy (fusion bonded epoxy) and acrylics. In another embodiment, the components comprising the water pan 504, the housing 102 and food pan 502, or a portion thereof, may comprise a layer that is ink-printable, i.e., a surface that allows for ink printing. In another embodiment, the components comprising the water pan 504, the housing 102 and food pan 502, or a portion thereof, may be opaque, transparent, semi-transparent, or translucent.

Additionally, in a preferred embodiment, the components comprising the water pan 504, the housing 102 and food pan 502, may be manufactured from sheet metal using forming machine tools known in the art for bending sheet and plate materials, such as a brake press, a bending machine, or the like. In press brake forming, a work piece is positioned over a die block and the die block presses the sheet metal to form a shape. The present invention supports the manufacturing of the components comprising the water pan 504, the housing 102 and food pan 502 from sheet metal using various types of bending on a press brake, such as air bending, bottoming, coining, three point bending, folding, wiping, rotary bending, roll bending, elastomer bending, an joggling. Lastly, the components comprising the water pan 504, the housing 102 and food pan 502 may be manufactured from a single piece of a molded material, such as a plastic.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A food warmer, comprising:
a water pan for holding water;
a housing for supporting the water pan;
a food pan supported by the water pan above the water in the water pan;
an electrical heating element located underneath, and in conductive contact with, the water pan, so as to heat the water in the water pan;
a first removable battery and a second removable battery for providing power to the electrical heating element; and
a processor conductively coupled with the electrical heating element and with the first and second removable batteries, wherein the processor is configured for:
engaging a switch for relaying power to the electrical heating element from the first battery;
detecting that the first battery has depleted below a predefined threshold; and
engaging a switch for relaying power to the electrical heating element from the second battery.

2. The food warmer of claim 1, further comprising a compartment coupled to the housing, the compartment for holding the first and second removable batteries.

3. The food warmer of claim 2, wherein the compartment comprises a removable shelf for holding the first and second removable batteries.

4. The food warmer of claim 2, further comprising one or more visual indicators on an exterior of the housing of the food warmer that indicate a current charge status of the first and second removable batteries.

5. The food warmer of claim 4, further comprising a power switch on an exterior of the housing of the food warmer, wherein the switch is configured for activating and deactivating the food warmer.

6. The food warmer of claim 2, further comprising an adjustable dial on an exterior of the housing of the food warmer for selecting a temperature for the food warmer.

7. The food warmer of claim 6, wherein the adjustable dial is communicatively coupled with the processor and wherein the processor is configured for adjusting a voltage provided to the electrical heating element from the first and second removable batteries.

8. The food warmer of claim 2, further comprising a display on an exterior of the housing of the food warmer for displaying a current temperature of the food warmer.

9. The food warmer of claim 5, further comprising a communications module including a radio frequency transmitter for transmitting a current charge status of each of the first and second removable batteries and a current temperature of the food warmer.

10. The food warmer of claim 2, further comprising one or more brackets located on a side of the housing for holding a lid of the food warmer.

11. A food warmer, comprising:
a water pan for holding water;
a housing for supporting the water pan;
a food pan supported by the water pan above the water in the water pan;
a lid for placement on top of the food pan;
an electrical heating element located underneath, and in conductive contact with, the water pan, so as to heat the water in the water pan;
a sensor coupled with the electrical heating element for sensing a current temperature of the electrical heating element;
a removable battery for providing power to the electrical heating element;
a user input interface located on an exterior of the food warmer, wherein a user may input a desired temperature for the food pan; and
a processor conductively coupled with the user input interface, the sensor, the electrical heating element and the removable battery, wherein the processor is configured for:
reading the desired temperature entered by the user;
engaging a switch for relaying power to the electrical heating element from the battery;
reading a current temperature of the electrical heating element from the sensor and determining that the current temperature is substantially equal to the desired temperature entered by the user; and
engaging a switch for withdrawing power to the electrical heating element from the battery.

12. The food warmer of claim 11, further comprising a compartment coupled to the housing, the compartment for holding the battery.

13. The food warmer of claim 12, wherein the compartment comprises a removable shelf for holding the battery.

14. The food warmer of claim 12, further comprising one or more visual indicators on an exterior of the housing of the food warmer that indicate a current charge status of the battery.

15. The food warmer of claim 14, further comprising a power switch on an exterior of the housing of the food warmer, wherein the switch is configured for activating and deactivating the food warmer.

16. The food warmer of claim 12, wherein the user input interface comprises an adjustable dial on an exterior of the housing of the food warmer for selecting a desired temperature for the food warmer.

17. The food warmer of claim 14, further comprising a sensor that senses a current charge status of the battery.

18. The food warmer of claim 12, further comprising a display on an exterior of the housing of the food warmer for displaying a current temperature of the electrical heating element.

19. The food warmer of claim 15, further comprising a communications module including a radio frequency transmitter for transmitting a current charge status of the battery and a current temperature of the electrical heating element.

20. A food warmer, comprising:
a water pan for holding water;
a housing for supporting the water pan;
a food pan supported by the water pan above the water in the water pan;
a lid for placement on top of the food pan;
an electrical heating element located underneath, and in conductive contact with, the water pan, so as to heat the water in the water pan;
a sensor coupled with the electrical heating element for sensing a current temperature of the electrical heating element;
a display located on the exterior of the food warmer for displaying a current temperature of the electrical heating element;
a removable battery for providing power to the electrical heating element;
a sensor that senses a current charge status of the battery;
a user input interface located on an exterior of the food warmer, wherein a user may input a desired temperature for the food pan;
a processor conductively coupled with the user input interface, the sensor, the electrical heating element and the removable battery, wherein the processor is configured for:
reading the desired temperature entered by the user;
engaging a switch for relaying power to the electrical heating element from the battery;
reading a current temperature of the electrical heating element from the sensor and determining that the current temperature is substantially equal to the desired temperature entered by the user; and
engaging a switch for withdrawing power to the electrical heating element from the battery; and
a communications module including a radio frequency transmitter for transmitting a current charge status of the battery and a current temperature of the electrical heating element.
